(19) United States
(12) Patent Application Publication
(10) Pub. No.: US 2020/0197847 A1
(43) Pub. Date: Jun. 25, 2020

(54) CYCLONE SEPARATOR AND METHODS FOR CONVEYING DRY BULK MATERIAL

(71) Applicant: Société des Produits Nestlé S.A., VEVEY (CH)

(72) Inventors: Dionicio Jantes, Ellisville, MO (US); Bryan Sawyer, Crestwood, MO (US)

(21) Appl. No.: 16/711,033

(22) Filed: Dec. 11, 2019

Related U.S. Application Data
(60) Provisional application No. 62/783,672, filed on Dec. 21, 2018.

(51) Int. Cl. B01D 45/16; B65G 53/60; B65G 53/48; B65G 53/08

(52) U.S. Cl. CPC B01D 45/16; B65G 53/08; B65G 53/48; B65G 53/60

(57) ABSTRACT

A cyclone type receiver can be used in a pneumatic conveyor system for accurately delivering a wide variety of particulate materials. A receiver may include a cylindrical body configured to hold a filter. The top end of the cylindrical body may include an air inlet for receiving a ducted air stream filled with a particulate material, and may be configured to convey the ducted air stream helically toward a conical section attached to the cylindrical section. The conical section may be configured to route the ducted air in a helical manner to remove the particulate material from the ducted air. In such a configuration, the filter and the conical section may remove particulate material, thereby preferably increasing the transfer accuracy of the system and reducing the footprint of a traditional pneumatic conveyor system.

### CROSS REFERENCE TO RELATED APPLICATIONS

This application claims priority to U.S. Provisional Application Ser. No. 62/783,672 filed Dec. 21, 2018, the disclosure of which is incorporated in its entirety herein by this reference.

### BACKGROUND

The present disclosure generally relates to cyclone separators that can be used in pneumatic conveying. A separator may be used to receive dry particulate material through a ducting system in a ducted air stream as part of a manufacturing line for processing food products.

Often, manufacturing lines are changed or upgraded as old products are discontinued and new products are added, or as new manufacturing processes are implemented throughout the manufacturing line. The recent industry trend of replacing artificial color ingredients with natural ones is one example where a change in manufacturing equipment and or processes may be required. Color additives and other ingredients from natural sources (e.g. vegetables or minerals) can be less soluble in water than synthetic ones. In these instances, there may be a need to modify the manufacturing equipment and processes by replacing existing liquid ingredient addition systems with dry bulk material (e.g. powder, seeds, colorants) addition systems.

This change often takes place within existing manufacturing facilities and is constrained by the original footprint within those facilities. Therefore, when considering pneumatic conveyance of product throughout a manufacturing space, efficiently using the existing space is a top priority in the design of the pneumatic conveyance system. Often, those designing such systems are challenged with balancing overall transfer accuracy and consistency of the pneumatic conveyance system with space constraints.

Additional considerations include the compatibility of equipment and/or process steps that take place before or after the conveyance of the dry bulk material. For example, in the case of food products produced with an extrusion step, the transition from the conveyor to the extruder is yet another important parameter for conveyor design. Therefore, there is a need for pneumatic conveyors with alternative compact designs for accurately, consistently and efficiently transferring dry bulk material and improved manufacturing systems in which they are employed.

### SUMMARY

The present disclosure is generally related to a cyclone separator for use in a pneumatic conveyor system which can be used for consistently and accurately delivering a variety of dry bulk material, particularly in space-constrained areas. In an exemplary embodiment, the cyclone separator can comprise an inlet duct, an outlet duct, a receiver positioned in a flow path between the inlet duct and the outlet duct and configured to direct air comprising a dry bulk material from the inlet duct to the outlet duct. In some embodiments, the receiver can comprise a lower conical section and an upper cylindrical section that define a pressure vessel. In some embodiments, a filter can be positioned within the flow path of the air comprising the dry bulk material. In one embodiment, the filter can be located in the upper cylindrical section of the separator. In some embodiments, the inlet duct and outlet duct can be positioned in the cylindrical section such that the air comprising the dry bulk material is directed into the cylindrical section, around the conical section helically, through the filter, and out of the outlet duct such that at least a portion of the dry bulk material is removed from the air. In some embodiments, the inlet duct can be positioned tangentially with respect to the wall of the upper cylindrical section and the inlet duct has an opening diameter Dᵢ from about 2.0 inches to about 5.0 inches. In another embodiment, the upper cylindrical section can have a diameter D from about 12 inches to about 31 inches and a height L_{b}. In another embodiment, the conical section can have a height L_{c} and an outlet of the conical section can have a diameter D_{d} from about 6 inches to about 10 inches In some embodiments, the conical section can comprise a centerline and an angle θ defined by (i) a horizontal plane perpendicular to the centerline and (ii) a sidewall of the conical section, wherein the angle θ can be from about 70 degrees to about 85 degrees, wherein the height L_{c} is calculated as TAN(θ) multiplied by a length L_{d}, wherein the length L_{d} is a first side of a right triangle formed with the sidewall of the conical section, wherein the sidewall is a hypotenuse of the right triangle and the height L_{c} is a second side of the right triangle opposite angle θ and the length L_{d} is calculated as the diameter D minus the diameter D_{d} divided by 2, and wherein the height L_{b} can be from about 8 to about 55 inches.

Another aspect of the present disclosure is generally related to a system for accurately conveying dry bulk material in an extrusion-based manufacturing process. The system can comprise a cyclone separator configured to separate the dry bulk material from a carrier air. The system can also comprise a filter positioned in an upper section of the cyclone separator, a feeder to store and feed the dry bulk material to the separator at a pre-determined rate, a first rotary valve configured between the feeder and the separator, a blower for generating the carrier air, a moisture controller for regulating a moisture content of the carrier air, a screw conveyor for conveying the dry bulk material further downstream, a second rotary valve for discharging the material from the separator to the screw conveyor. The system can also comprises a first source of air for removing buildup in the separator. The system can also further comprise an in-line filter positioned between and outlet duct of the cyclone separator and the blower.

Another aspect of the present disclosure is generally related to a method for accurately and consistently introducing a volume of dry bulk material into a pre-finished food composition in an extrusion based manufacturing process. The method can comprise feeding a volume of dry bulk material from a feeder into a ducted flow of carrier air at a pre-determined rate, directing the flow of carrier air comprising the volume of dry bulk material into an inlet of a cyclone separator, controlling a moisture of the carrier air with a dehumidifier configured in a path of the carrier air, separating at least a portion of the volume of dry bulk material from the carrier air and allowing the portion to pass through an outlet of the separator into a rotary valve, and conveying the portion of dry bulk material from the rotary valve into a vessel comprising a pre-finished food composition. The vessel can be an extruder or a coater.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a process view of the pneumatic conveyor system in accordance with an embodiment of the present application.

FIG. 2 illustrates a side view of the conical and cylindrical sections comprising the receiver housing in accordance with an embodiment of the present application.

FIG. 3 illustrates a simplified side view of the cyclone separator in accordance with an embodiment of the present application.

### DETAILED DESCRIPTION OF EXAMPLE EMBODIMENTS

Detailed embodiments of devices and methods are disclosed herein. However, it is to be understood that the disclosed embodiments are merely exemplary of the devices and methods, which may be embodied in various forms. Therefore, specific functional details disclosed herein are not to be interpreted as limiting, but merely as a basis for the claims as a representative example for teaching one skilled in the art to variously employ the present disclosure.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

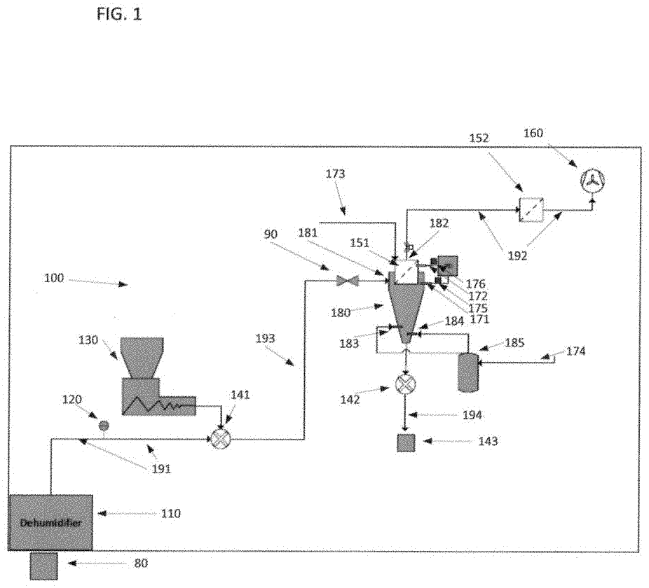

The present embodiment relates to cyclone separators. Such cyclone separators can be used in a pneumatic conveyor system for consistently and accurately delivering a wide variety of dry bulk material. FIG. 1 illustrates a process view of a pneumatic conveyor system 100. The pneumatic conveyor system 100 may comprise a dehumidifier 110 at an air inlet 80. The installation and/or use of the dehumidifier 110 may be dependent on local weather conditions or the colorants/ingredients to be used as the particulate material. The dehumidifier 110 may be selectively positioned within the system 100 for the conveyance of hygroscopic ingredients in processing areas where the relative humidity exceeds about 40%.

Air from the dehumidifier 110 may be drawn into an inlet duct 191. The inlet duct 191 may comprise an in-line air flow meter 120. The inlet duct 191 may further comprise a first valve 141. The first valve 141 may be a rotary valve, or other valve known to those of skill in the art. The first valve 141 may be coated with materials formulated to reduce particulate buildup on the first valve 141. A feeder 130 may contain dry bulk material. The feeder 130 may connect to the first valve 141 for injecting dry bulk material into the inlet duct 191. In some embodiments, the dry bulk material is of various types. For example, the dry bulk material can be powder, seeds, granules or grains. For example, the feeder 130 may contain one or more of dry ingredients (e.g. water insoluble ingredients) that can be incorporated into or onto a pre-finished food composition. For example, the dry ingredient can be vitamins, minerals, colorants, probiotics or mixtures thereof. In still other embodiments, the feeder 130 may contain multiple ingredients, or comprise several separate feeders each configured to convey a separate ingredient. Some exemplary embodiments include but are not limited to volumetric bulk material feeders and gravimetric bulk material feeders. The feeder 130 can be of the single-screw or twin-screw type. The gravimetric bulk material feeders, also known as loss-in-weight or weighfeeders, are designed to provide a constant flow of material, based on the weight of material fed, within a specified unit of time. The feeder 130 may be selected according to the operational rates of the process and the particle size and bulk density of the selected dry bulk material. For example, a pre-determined air flow rate may be set to about 100 ft³/min. to about 300 ft³/min and a bulk density of a dry bulk material may range from about 20 lb/ft³ to about 90 lb/ft³. In some embodiments, a pre-determined transfer rate can be from about 0.05 lb/min to about 30.0 lb/min. In some embodiments, the dry bulk material can have a particle size from about 20 μm to about 5000 μm. In some embodiments, the dry bulk material can have a particle size from about 50 μm to about 3500 μm. In some embodiments, the dry bulk material can have a particle size from about 75 μm to about 3350 μm.

The first valve 141 may be connected to a middle duct 193. In one embodiment, the middle duct 193 receives air from the inlet duct 191 that comprises dry bulk material from the feeder 130 that is injected into the air at the first valve 141. The middle duct 193 may connect to a separator 180 at a receiver inlet 181. In some embodiments, the middle duct 193 may comprise a slide gate valve 90. The slide gate valve 90 may be selectively opened or closed. When the slide gate valve 90 is closed, the slide gate valve 90 may isolate the separator 180 from the feeder 130. The slide gate valve 90 can be used in a cleaning operation to prevent particulate from moving in the direction opposite of normal flow through the middle duct 193. The direction of normal flow of air is generally from the air inlet 80, past the feeder 130 where dry bulk material is added, into the separator 180 where the dry bulk material is separated from the ducted air, wherein at least a portion of the dry bulk material exits the outlet of the separator through a rotary valve 142 and air exits through a filter 151 and out through the blower 160. In some embodiments, particulate may be prevented from moving in the direction opposite of normal flow in a cleaning operation (through the middle duct 193 from the separator 180 to the air inlet 80) without the use of the slide gate valve 90 by maintaining the pressure in the separator 180 below the pressure at the receiver inlet 181.

In some embodiments, air may be drawn into the air inlet 80 by negative pressure created by a blower 160. The air inlet 80 may be connected to the inlet duct 191, which may be connected to the middle duct 193, which may be connected to the separator 180, which may be connected to an outlet duct 192 at a receiver outlet 182. The outlet duct 192 may be connected to the blower 160. In this manner, negative pressure may be applied to the entire duct system (e.g. the ducts 191, 192 and 193) as well as the separator 180, and may operate to move the dry bulk material combined with the ducted air from the feeder 130 to the separator 180 where the dry bulk material may be removed from the ducted air.

In an embodiment, the separator comprises an upper cylindrical section 210 and a lower conical section 220 which together define a receiver (e.g. pressure vessel). In an embodiment the upper cylindrical section 210 comprises a receiver inlet 181 for receiving ducted air comprising dry bulk material and an outlet for conveying air from the separator 180 with the dry bulk material removed.

In some embodiments, the receiver inlet 181 has a centerline and the receiver inlet 181 is positioned such that the distance between the inlet centerline and a top of the cylindrical section is from about 2 inches to about 10 inches. A first filter 151 may be contained within the upper cylindrical section 210. The separator 180 may further comprise a first compressed air inlet line 173, a pressure sensing location 171 and a pressure sensing location 172. The first compressed air inlet line 173 may be configured such that compressed air enters on the downstream side of the first filter 151, the downstream side being the side facing the outlet duct 192. It is optional that the pressure sensing locations 171 and 172 are selected such that the pressure sensor location 171 may be on the dirty, upstream, particulate material-saturated side of the first filter 151 and the pressure sensor location 172 may be located on the clean, downstream side of the first filter 151. Such a relative arrangement can be used by pressure sensors 175 and 176 located at each of the pressure sensing locations 171 and 172 to determine a pressure reading at the pressure sensing locations 171 and 172.

The pressure differential between a pressure reading at each of the pressure sensing locations 171 and 172 may identify a pressure drop over the first filter 151. This pressure drop can be used to determine when the first filter 151 is sufficiently dirty to require a cleaning cycle. If the pressure drop is not sufficiently dirty to require a cleaning cycle, then the system 100 may continue to operate normally without initiating a cleaning cycle. A controller 510 may be configured to automatically initiate a cleaning sequence when the pressure drop over the first filter 151 reaches a pre-determined threshold.

The cleaning cycle may comprise injecting compressed air into the first compressed air inlet line 173 against the first filter 151 to blow accumulated particulate off of the first filter 151. At the same time, the first compressed air inlet line 173 may apply air to the first filter 151 and the blower 160 may be still operating to lower the overall pressure of the separator 180 below the pressure at the receiver inlet 181. In this manner, the slide gate valve 90 may be removed because the lower pressure within the separator 180 prevents accumulated particulate from travelling into the middle duct 193. A cleaning cycle may comprise the first filter 151 being removed and replaced automatically or by a user in addition to the compressed air cleaning process described herein. In an exemplary embodiment, the separator 180 may retain a negative pressure of about 30 psi to about 35 psi throughout the entirety of a cleaning cycle of the system 100, down from a normal operating pressure of about 40 psi.

Some embodiments may further comprise a first air sweep 183 and a second air sweep 184 positioned in the conical section of the separator 180. In some embodiments, within the cleaning cycle, or during normal operation of the separator 180, the air sweeps 183 and 184 may operate to remove dry bulk material from the sides of the conical section and direct dry bulk material down the conical section of the separator 180. It should be understood, that the exemplary embodiments herein show two air sweeps, but that more air sweeps in various locations throughout the conical or cylindrical sections of the separator 180 are encompassed by the present disclosures. In one embodiment, the air sweeps are diametrically opposed and vertically offset with respect to each other. Further, fluidizers may be used in conjunction with or in place of the air sweeps shown herein. In an embodiment, the air sweeps 183 and 184 are connected to a compressed air tank 185. The compressed air tank 185 may be fed compressed air through a second compressed air inlet line 174, the compressed air tank 185 serving to provide a sufficient supply of compressed air to operate the air sweeps 183 and 184 while operation is desired.

The separator 180 may further comprise an outlet line 194, which may be configured to flow dry bulk material accumulated within the separator 180 out of the separator 180 to be further utilized for a next manufacturing operation. In an embodiment, a second valve 142 is placed in the outlet line 194 to regulate the removal of particulate from the separator 180. In an embodiment, the second valve 142 is a rotary valve. It is contemplated that the valves 141 and 142 could be of a hygienic design, as the system 100 may be used to process food for human consumption. The outlet line 194 may further comprise a screw conveyor 143, which can be used to convey dry bulk material further downstream. The screw conveyor may be configured to convey material to an extruder or a coater for introducing the dry bulk material into or onto a pre-finished food composition.

In some embodiments, the outlet duct 192 may comprise a second filter 152. The second filter 152 may be positioned in the outlet duct 192, where dry bulk material has already been removed from the ducted air at the separator 180. However, in some embodiments, due to normal transport efficiency or system leaks, some dry bulk material may move beyond the separator 180 and through the outlet duct. In such a scenario, the second filter 152 may minimize or prevent dry bulk material from entering into the blower 160.

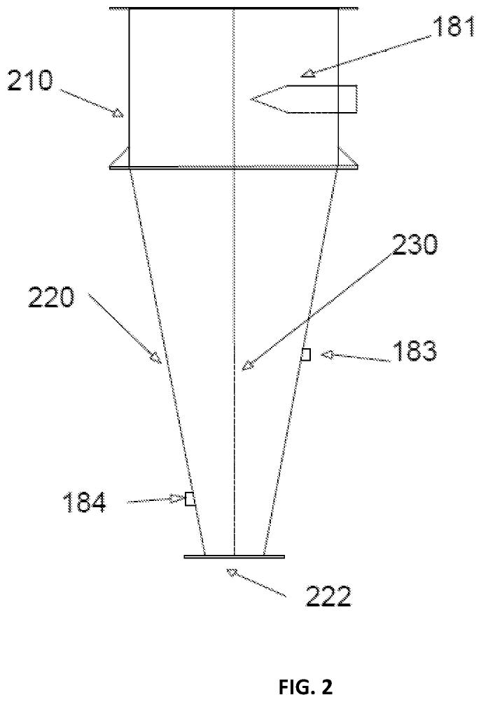

FIG. 2 illustrates a side view of a cylindrical section 210 and a conical section 220 comprising the receiver portion of the separator 180. The receiver inlet 181 may be located tangentially to a centerline 230 of the cylindrical section 210 such as the receiver inlet 181 shown in FIG. 2. The centerline 230 may extend vertically through the cylindrical section 210 and/or conical section 220 at a vector defined by a midpoint of a diameter of a circle created from any planar-section of the cylindrical section 210 and/or the conical section 220. The receiver inlet 181 may comprise (as shown in FIG. 2a) a teardrop shape to maintain a circular profile from (as shown in FIG. 2b) the receiver inlet 181 direction. Such a configuration may simplify manufacturing and assembly of the connection between the middle duct (193, not shown) and the receiver inlet 181. Unexpectedly, it has been found that to achieve maximum transfer accuracy of the system 100, the receiver inlet 181 may be vertically aligned along the centerline 230 of the cylindrical section 210 with the receiver outlet 182.

As discussed in regard to FIG. 1, the locations of the air sweeps 183 and 184 are not limited to those shown herein, and the location may be configured differently depending on the desired bulk material used in the separator 180. A conical outlet 222 may be selectively positioned to lead to the outlet line 194, the second valve 142, or the screw conveyor 143, depending on the embodiment.

As shown, embodiments of the cylindrical section 210 and the conical section 220 may comprise a durable material, yet one that eases the manufacturing of the elements, because the overall structure of the sections may be circular. For example, the separator 180 may be manufactured from stainless steel AISI 304, however there may be other suitable materials. As such, the separator 180 is not limited to stainless steel. The interior surface of the cylindrical section 210, the conical section 220, or any other surface that may come into contact with the dry bulk material used in the system 100 may optionally be coated with a food-contact approved material to minimize particulate material buildup.

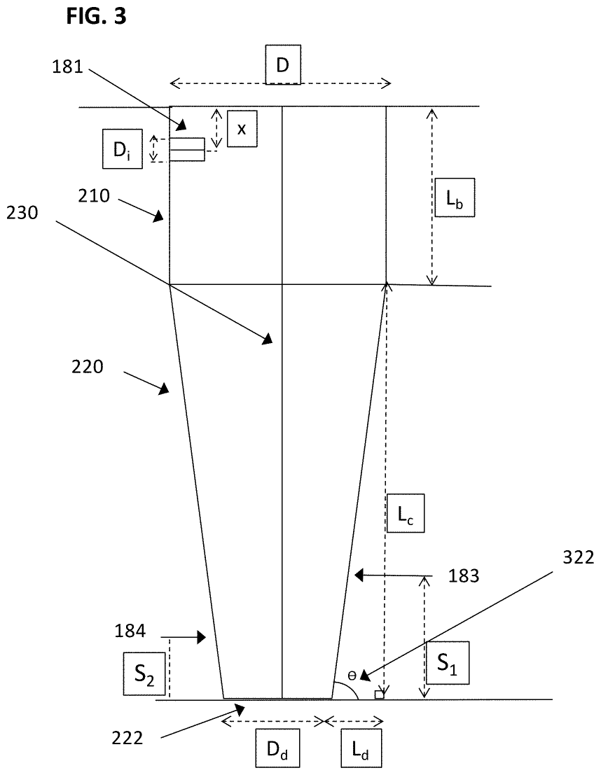

FIG. 3 illustrates a simplified side view of an embodiment of the conical section 220 and the cylindrical section 210 of the separator 180. In one embodiment of the conical section 220, an angle of conical section 322 (θ) is from about 70 degrees to about 85 degrees (i.e. the angle of the conical section 220 defined by the conical outlet 222 and a sidewall of the conical section 220). A height of the conical section 220 is given by a height L_{c}. The placement of the air sweeps 183 and 184 is shown for reference The distances S₁ and S₂ represent the vertical distance of the air sweeps from the conical outlet. In some embodiments, S₁ is about 3 inches to about 5 inches vertically above the conical outlet and S₂ is about 5 inches to about 25 inches vertically above the conical outlet. In some embodiments, the air sweeps 183 and 184 are offset vertically relative to each other. The conical outlet 222 has a diameter D_{d}. The cylindrical section 210 has a height L_{b} and a diameter D. In general, the efficiency of the separator 180 may be dictated by the number of rotations around the centerline 230 that the air comprising the dry bulk material makes when entering the receiver inlet 181 before reaching the bottom of the conical section 220. The number of rotations around the centerline 230 the air makes may be generally a function of one or more of the air inlet velocity, the particle size of the dry bulk material in the air, the temperature of the air comprising the dry bulk material, and the dimensions of the separator 180.

Another aspect of the disclosure in the present application is a method for accurately and consistently introducing a volume of dry bulk material into or onto a pre-finished food composition in an extrusion-based manufacturing process comprising feeding a volume of dry bulk material from a feeder into a ducted flow of carrier air at a pre-determined rate, directing the flow of carrier air comprising the volume of dry bulk material into an inlet duct of a cyclone separator, controlling a moisture of the carrier air with a dehumidifier configured in a path of the carrier air, separating a portion of the volume of dry bulk material from the carrier air and allowing the volume to pass through an outlet of the separator into a rotary valve, conveying the volume of dry bulk material from the rotary valve into a vessel comprising a pre-finished food composition, the vessel selected from an extruder and a coater.

In some embodiments, the pre-finished food composition is a pre-finished food composition for use in production of pet food products. For example, the pre-finished food composition is a dough or dough-like substance that can be further processed into a kibble or a treat (e.g. shaped by an extruder). In some embodiments, the pre-finished food composition can be a dry kibble that can be further processed, for example coated with a liquid coating or a dry coating, in a tumbler, rotary coater or drum coater.

In some embodiments, the dry bulk material can be powder, seeds, granules or grains. In some embodiments, the dry bulk material can have very limited solubility in water or can be water-insoluble. For example, in some embodiments the dry bulk material can be vitamins, minerals, colorants, probiotics or mixtures thereof.

In some embodiments, the dry bulk material has a particle size from about 20 μm to about 5000 μm. In some embodiments, the dry bulk material can have a particle size from about 50 μm to about 3500 μm. In some embodiments, the dry bulk material can have a particle size from about 75 μm to about 3350 μm. In some embodiments, the dry bulk material that has a bulk density from about 20 lb/ft³ to about 90 lb/ft³.

In some embodiments, the feeding of the volume of dry bulk material is performed at a pre-determined rate. The rate can be a function of the feeder setting, the air flow rate through the conveyor system and a combination thereof. In some embodiments, the feeding is performed at a pre-determined rate of about 0.05 lb/min to about 30.0 lb/min. In another embodiment, the feeding is performed at a pre-determined rate of about 0.05 lb/min to about 10.0 lb/min. In one embodiment, the feeding is performed at a pre-determined rate of about 0.05 lb/min to about 5.0 lb/min. In one embodiment, the feeding is performed at a pre-determined rate of about 0.05 lb/min to about 3.0 lb/min.

### EXAMPLE

Non-limiting examples are provided herein for clarity of the above features. It has been unexpectedly found that the cyclone separators with exemplary embodiments such as an angle θ of 80° and a conical outlet D_{d}, defined as 6 in, 7 in, 8 in, 9 in, or 10 in and additional parameters of D, Ld, Lc, and Lb, further defined as in Table 1 below, show transfer efficiencies greater than 95% with dry bulk material having varied particle sizes and bulk densities.

TABLE 1

| L_{d} | L_{c} | L_{b} | D (D_{d} = 6) | D (D_{d} = 7) | D (D_{d} = 8) | D (D_{d} = 9) | D (D_{d} = 10) |
|---|---|---|---|---|---|---|---|
| 2 | 11.34 | 48.65 | | | 12 | 13 | 14 |
| 3 | 17.01 | 42.99 | 12 | 13 | 14 | 15 | 16 |
| 4 | 22.68 | 37.31 | 14 | 15 | 16 | 17 | 18 |
| 5 | 28.36 | 31.64 | 16 | 17 | 18 | 19 | 20 |
| 6 | 34.03 | 25.97 | 18 | 19 | 20 | 21 | 22 |
| 7 | 39.70 | 20.30 | 20 | 21 | 22 | 23 | 24 |
| 8 | 45.37 | 14.63 | 22 | 23 | 24 | 25 | 26 |
| 9 | 51.04 | 8.96 | 24 | 25 | 26 | 27 | 28 |

Table 2 below shows resultant removal efficiency by particle size of the above-described embodiments.

TABLE 2
Particle Size vs Removal Efficiency

| Size Ranges (μm) | Removal Efficiency (%) |
|---|---|
| 0-75 | 98.2 |
| 75-150 | 99.8 |
| 150-300 | 99.9 |
| 300-1400 | 99.9 |
| 1400-1700 | 99.9 |
| >1700 | 99.9 |

As shown in Table 2, the resultant efficiencies are applicable through a large range of particle sizes, thereby allowing the contemplated embodiments for various particulates desired in the manufacturing process. While the resulting data is shown herein for some embodiments of the separator 180, a suitable range of the angle of the conical section 322 may be from about 70 degrees to about 85 degrees when the diameter D_{d} is from about 6 inches to about 10 inches and the diameter D is from about 12 inches to about 31 inches. A configuration in these contemplated dimensional ranges has been shown to yield efficiencies of above about 95% for varied particle sizes. Such flexibility allows variable sizing of the separator 180, thereby providing a flexible configuration of the system 100 while still maintaining high transfer accuracy of the system 100. As a result, the separator 180 may be adapted to be used in space-constrained areas within a manufacturing facility. Transfer efficiencies can depend on a number of factors including the dimensions and specifications of the separator 180 and the conveyor system 100 comprising the separator 180, the particle size of the dry bulk material, and the bulk density of the dry bulk material. In some embodiments, the transfer efficiencies can be from about 75% to about 100%, from about 80% to about 100%, from about 90% to about 100%, from about 95% to about 100% or from about 95% to about 100%.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims. Further, the present embodiments are thus not to be limited to the precise details of methodology or construction set forth above as such variations and modification are intended to be included within the scope of the present disclosure. Moreover, unless specifically stated any use of the terms first, second, etc. do not denote any order or importance, but rather the terms first, second, etc. are merely used to distinguish one element from another.

What is claimed is:

1. A cyclone separator comprising:
an inlet duct;
an outlet duct;
a receiver positioned in a flow path between the inlet duct and the outlet duct and configured to direct air comprising a dry bulk material from the inlet duct to the outlet duct;
a filter within the receiver and positioned within the flow path of the air comprising the dry bulk material, wherein the receiver comprises a lower conical section and an upper cylindrical section that together define a pressure vessel,
wherein the inlet duct and the outlet duct are positioned in the cylindrical section such that the air comprising the dry bulk material is directed into the cylindrical section, around the conical section helically, through the filter, and out of the outlet duct such that at least a portion of the dry bulk material is removed from the air and the inlet duct is positioned tangentially with respect to the wall of the cylindrical section and the inlet duct has an opening diameter Di from about 2.0 inches to about 5.0 inches,
wherein the cylindrical section has a diameter D from about 12 inches to about 31 inches and a height Lb and the conical section has a height Lc and an outlet of the conical section has a diameter Dd from 6 inches to 10 inches,
wherein the conical section comprises a centerline and an angle θ defined by (i) a horizontal plane perpendicular to the centerline and (ii) a sidewall of the conical section wherein the angle θ is from 70 degrees to 85 degrees,
wherein the height Lc is calculated as TAN(θ) multiplied by a length Ld wherein the length Ld is a first side of a right triangle formed with the sidewall of the conical section wherein the sidewall is a hypotenuse of the right triangle and the height Lc is a second side of the right triangle opposite angle θ and the length Ld is calculated as the diameter D minus the diameter Dd divided by 2, and
wherein the height Lb is from about 8 inches to about 55 inches.

2. The cyclone separator according to claim 1, further comprising a pair of air sweeps, wherein the air sweeps are located in the conical section and are diametrically opposed and vertically offset with respect to each other.

3. The cyclone separator according to claim 1, wherein the inlet duct has a centerline and the centerline is from about 2 inches to about 10 inches from a top of the cylindrical section.

4. The cyclone separator according to claim 1, wherein a transfer efficiency of the dry bulk material is from about 75 percent to about 100 percent.

5. The cyclone separator according to claim 1, wherein the dry bulk material comprises powder, seeds, granules, or grain.

6. A system for accurately conveying dry bulk material in an extrusion-based manufacturing process comprising:
a cyclone separator configured to separate the dry bulk material from a carrier air;
a filter positioned in an upper section of the cyclone separator;
a feeder to store and feed the dry bulk material to the separator at a pre-determined rate;
a first rotary valve configured between the feeder and the separator;
a blower for generating the carrier air;
a moisture controller for regulating a moisture content of the carrier air;
a screw conveyor for conveying the dry bulk material further downstream;
a second rotary valve for discharging the material from the separator to the screw conveyor;
a first source of air for removing build up in the separator; and
an in-line filter positioned between an outlet duct of the cyclone separator and the blower.

7. The system according to claim 6, further comprising a vessel configured downstream of the cyclone separator for receiving the dry bulk material and incorporating the dry bulk material into or onto a pre-finished food composition.

8. The system according to claim 6, further comprising a second source of air for cleaning the filter.

9. The system according to claim 6, wherein the pre-determined rate is from about 0.05 lb/min to about 30.0 lb/min.

10. The system according to claim 6, wherein the feeder is a loss-in-weight feeder.

11. A method for accurately and consistently introducing a volume of dry bulk material into or onto a pre-finished food composition in an extrusion-based manufacturing process comprising:
feeding a volume of dry bulk material from a feeder into a ducted flow of carrier air at a pre-determined rate;
directing the flow of carrier air comprising the volume of dry bulk material into an inlet duct of a cyclone filter separator;
controlling a moisture of the carrier air with a dehumidifier configured in a path of the carrier air;
separating a portion of the volume of dry bulk material from the carrier air and allowing the volume to pass through an outlet of the separator into a rotary valve;
conveying the volume of dry bulk material from the rotary valve into a vessel comprising the pre-finished food composition, the vessel selected from an extruder and a coater.

12. The method according to claim 11, wherein the pre-determined rate is from about 0.05 lb/min to about 30.0 lb/min.

13. The method according to claim 11, wherein the volume of dry bulk material comprising powder, seeds, granules, or grains.

14. The method according to claim 11, wherein the volume of dry bulk material comprises vitamins, minerals, colorants, probiotics or mixtures thereof.

15. The method according to claim 11, wherein the volume of bulk material has a particle size from about 20 um to about 5000 um.

16. The method according to claim 11, wherein the volume of dry bulk material has a bulk density from about 20 lb/ft³ to about 90 lb/ft³.

17. The method according to claim 11, wherein the method is continuous.

18. The method according to claim 11, further comprising a filter cleaning sequence.

19. The method according to claim 18, wherein the filter cleaning sequence is performed concurrently with the separating.

20. The method according to claim 11, wherein the method has a dry bulk material transfer efficiency from about 75 percent to about 100 percent.
